(19) United States
(12) Patent Application Publication
(10) Pub. No.: US 2011/0193779 A1
(43) Pub. Date: Aug. 11, 2011

(54) System and Method for Facilitating Social Networking

(76) Inventor: Herbert Williams, Memphis, TN (US)

(21) Appl. No.: 12/870,077

(22) Filed: Aug. 27, 2010

Related U.S. Application Data
(60) Provisional application No. 61/337,569, filed on Feb. 8, 2010.

(51) Int. Cl. G06F 3/033; G09G 5/00; G08B 5/00

(52) U.S. Cl. 345/163; 345/156; 340/815.4

(57) ABSTRACT

A system and method for facilitating social networking is contemplated. The system may be used in a venue such as a restaurant, cafeteria or nightclub. The contemplated system includes one or more social networking devices capable of providing non-verbal indicators to other users of the system. The non-verbal indicators may be color-coded visual indicators such as lights (e.g. LEDs). By way of example, the color-coded visual indicators may be placed on or around tables and may be configured to indicate a level of participation by an individual or group in the social networking system. The visual indicators may also be integrated into apparel such as a wristband, belt, headband, lightweight vest or arm band and worn by a user that wishes to participate in the social networking system at such a venue that supports the social networking system. The system may also provide simultaneous conveyance of multiple non-verbal indicators. Each non-verbal indicator may correspond to a desired level of social interaction or an attribute (e.g. a particular political party, a team affiliation, or marital status) associated with the user or group using the device.

### RELATED APPLICATIONS

This application claims the benefit of U.S. Provisional Patent Application Ser. No. 61/337,569 titled System and Method for Facilitating Social Networking filed on Feb. 8, 2010 by the inventor of the present application, the contents of which are incorporated herein by reference.

### FIELD OF THE INVENTION

The present invention relates generally to social networking and in particular to a system and method for facilitating social networking in a live environment.

### BACKGROUND OF THE INVENTION

Currently there are a number of solutions for facilitating social networking. Some of these solutions (e.g. LinkedIn, MySpace and Facebook) attempt to facilitate social networking in a virtual sense, but these solutions fail to meet the needs of the industry because they do not facilitate social interaction in a real-time physical environment. Other solutions such as speed-dating or even blind dating attempt to facilitate individuals meetings on a more personal basis, but these solutions are similarly unable to meet the needs of the industry because their focus and target participants are small in scope and/or may be of a romantic nature.

It would be desirable to have a device or system that can be used to facilitate social interaction between people in a real-world setting. Furthermore, it would be desirable to have a device or system that facilitates real-world social interaction in an organized, safe and socially engaging manner. Furthermore, it would be desirable to have a device that helps establishments improve seating efficiency thereby potentially increasing revenue and helping to promote humanities social progression. Still further, it would be desirable to have a device and system with these noted benefits that is simple, inexpensive to manufacture and operate and improves the establishments' décor. Still further, it would be desirable to have a device that encourages people to leave their private computing space and attend social gatherings. Therefore, there currently exists a need in the industry for a system and associated method that promotes the above benefits in a safe and progressive manner.

### SUMMARY OF THE INVENTION

The present invention advantageously fills the aforementioned deficiencies by providing a system and method for facilitating social networking in a physical environment. The social networking invention described herein is designed to facilitate meetings and events attended by two or more (even many) participants, who may or may not be previously acquainted. It is particularly useful where the social venue, social activities and discussion topics are varied, ever changing and may be directed by the participants, an establishment, or an online system. It is designed to help create an atmosphere and environment of goodwill that is conducive to meeting old friends and making new ones with its ability to offer non-verbal invitations to both acquaintances and non-acquaintance alike, combined with its online connection.

Through the use of a device and/or associated system the invention advantageously facilitates real-world social interaction among acquaintances and/or non-acquaintances in an organized, safe and socially engaging manner. In fact, in one particular version the invention can be implemented for use to facilitate ice-breaker activities among and between individuals who are just meeting for the first time.

By implementing the invention, an establishment or group may create a friendly, cordial and inviting atmosphere where the participants can engage in interaction in a non-threatening manner, even approaching individuals they do not know. This atmosphere is facilitated through the use of indicator lights or other visual indicator means capable of providing a non-verbal open invitation. Such non-verbal signals can allow an approaching individual or group to know whether they are invited to join the social networking table, section, or party. Such non-verbal signals could also be used to indicate a willingness to receive or accept solicitations or visitors. Still further, the non-verbal signals can provide information about the individual or group associated with the signal so as to convey information about the background, desires or wishes of the individual or group displaying the non-verbal signals.

Whether in a user's home town, a different city or foreign country, the invention may be utilized by individuals or groups and other participants may through the non-verbal signal obtain a non-verbal invitation to engage socially with other participants. Furthermore, the invention facilitates real-time social interaction while in large public forums such as sporting events or conventions, and is particularly well adapted for situations where large groups of individuals have at least some common interest of one kind or another but do not know many, or any, individuals. Thus the invention is ideal for use during college orientation, for example.

The interactive device could be used to provide trivia entertainment or simple games like bingo during halftime or during breaks at conventions or sporting events. In this manner, the device is used to provide a game within a game or an activity within an activity. Given today's multitasking society, the concept of a game within a game may be well received. For example, winner of the trivia game could win team gifts or game tickets.

The invention described herein is in its broadest sense a social networking system and method for use. The invention may be implemented in a venue such as a restaurant, cafeteria, nightclub, convention or anywhere where there are two or more people gathered. The system includes one or more social networking devices capable of providing non-verbal indicators to other users of the system. The non-verbal indicators may be color-coded visual indicators such as lights (e.g. LEDs). By way of example, the color-coded visual indicators may be placed on or around tables and may be configured to indicate a level of participation by an individual or group in the social networking system. The visual indicators may also be integrated into apparel such as a wristband, belt, arm band or other apparel or accessories, such as jewelry. The visual indicators can be worn by a user that wishes to participate in the social networking system, ideally but not necessarily being used at a venue that supports the social networking system.

The visual indicators are color-coded and may be controlled by the users of the device via an integrated control element such as a switch. By way of example, the visual indicators can be changed between one of the following colors, a blinking mode, or placed in an “OFF” or “NOT PARTICIPATING” state: Lights of a first color (e.g., green) may indicate that the table is participating in social networking and that seating is available; Lights of a second color (e.g., yellow) may indicate that the table is participating in social networking and seating may be available; and Lights of a third color (e.g., red) may indicate that the table is participating in social networking but number of social networking participates is complete. There are no limits to the number of different signal colors or color combinations that may be used to convey non-verbal information or nuance on such information. It is possible that the colors be different (which is preferred), but it is also possible that one or more of the colors (i.e., first, second, third, etc.) are same, perhaps varying in intensity or perhaps being organized in a certain pattern so that the configuration of illumination (for example) would convey the particular non-verbal meaning rather than a particular color. Still further, a blinking or flashing mode may be used to further promote social activity or function by conveying meaning as defined by some understood or predetermined convention. Of course, the blinking or flashing may be random, but the pattern of blinking or flashing may also convey still further and more nuanced information, and the blinking or flashing could even employ known language conventions, such as Morse code, which could add even more layers of information and nuance to the non-verbal communication.

Optionally, the device may support simultaneous conveyance of multiple non-verbal indicators. By way of example, the multiple non-verbal indicators may be multiple lights (or sets of lights) displaying different colors. In such an embodiment, each color may correspond to a desired level of social interaction or an attribute associated with the user or group using the device. By way of example, colors may be selected to indicate an association with a particular political party, a team affiliation, marital status, or other similar personal or group attribute. The lights may also be arranged in groups (e.g. by column) with each group corresponding to a particular type or category of non-verbal message. In this manner, more detailed non-verbal messages may be conveyed.

Optionally, the contemplated system may also include signs placed on the participating tables or in the designated area with additional information about the social networking system. The system may also be linked to one or more online social networking systems (e.g. LinkedIn, Facebook, MySpace, Twitter). The social networking systems may be accessible and linked via kiosk-type terminals or may facilitate online discussion topics being continued in a face-to-face setting. Still further, use of the invention may be previously coordinated through one or more online social networking systems by providing a common lexicon for those individuals and groups participating in the social interactivity facilitated by the system and associated device.

The contemplated system may be linked to the online social networking systems by the site establishing a forum and posting national, regional, local, or international discussion topics in the social forum. Participants can access the discussion forum and topics via their mobile device or the establishment may provide courtesy interactive kiosks with access to the social networking site and forum. The system may also be configured to allow participants to submit real-time feedback or vote on the current function (e.g. concert, convention, corporate event or restaurant). This real time feedback would be most beneficial to the event host, planners, management, etc.

Additionally, providing open, public kiosk devices with online access provides a positive, collaborative teaching facility that further educates participants of online social networking and increases the sites membership. Furthermore, the online site could allow participants to post or vote on current or future discussion topics/activities. By utilizing the contemplated system to bring online social networking to a public forum, blogging, tweeting, and discussion forums take on a different and more exciting element. The courtesy kiosks make it more convenient and easier to host blogging and twit parties in a public venue.

For example, via an arm band or courtesy kiosk, participants at a sporting event, awards program, or convention may send real-time feedback of the games MVP, show performances, committee nominees, or a number of other items. In this instance, the device(s) are used in a real time survey/feedback manner and the results may be posted for access in near real time.

The contemplated social networking system and associated device uniquely facilitate face-to-face human interaction in a physical environment unlike known online networking systems. The system can be used to complement existing online systems and/or to operate as an independent system. Moreover, the system and associated device allow individuals, group users or establishments to participating in social networking in the real world, which may be carrying over from online networking, while providing controls allowing participants to control the conveyed level of social networking participation. The device is also portable, easy to operate, inexpensive to manufacture, and social engaging.

Among other things, it is an object of the present invention to provide a system and method of facilitating social networking that does not suffer from any of the problems or deficiencies associated with prior solutions.

It is still further an object of the present invention to provide a system and method that facilitates real-world social interaction in an organized, safe and socially engaging manner.

It is still further an object of the present invention to provide a system and method that helps establishments improve seating efficiency or increase up-sales, thereby potentially increasing revenue and helping to promote humanities social progression.

Further objects of the invention include providing a device and system that is simple to operate, relatively inexpensive to manufacture and improves an establishments' décor and level of social engagement.

Further objectives of the invention include providing a safe and organized system for acquaintances and/or non-acquaintances to socially interact on a basic human and socially friendly level. It can also be a vehicle for face-to-face interactive sharing of ideas, thoughts and general conversation with acquaintances and/or non-acquaintances in a safe, friendly and socially inviting manner. Still further benefits of the invention include establishing a system that connects the general public, including some participants who may not be computer savvy, with online sites hosting national, regional, local or international discussion forums in a socially inviting setting.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a block diagram illustrating a social networking system in accordance with an exemplary embodiment of the invention.

FIG. 2 is a block diagram illustrating a social networking system in accordance with another exemplary embodiment of the invention.

FIG. 3 is a perspective view of a social networking device in accordance with an exemplary embodiment of the invention.

FIG. 4 is a perspective view of a social networking device in accordance with another exemplary embodiment of the invention.

FIG. 5A is a perspective view of a social networking system in accordance with another exemplary embodiment of the invention.

FIG. 5B is a perspective view of a social networking system in accordance with another exemplary embodiment of the invention.

FIG. 6 is a flow diagram illustrating a social networking process in accordance with an exemplary embodiment of the invention.

FIG. 7 is a flow diagram illustrating a social networking process in accordance with another exemplary embodiment of the invention.

FIG. 8 is a flow diagram illustrating a social networking process in accordance with another exemplary embodiment of the invention.

FIG. 9 is a perspective view of a social networking device in accordance with another exemplary embodiment of the invention.

FIG. 10 is a perspective view of a social networking device in accordance with another exemplary embodiment of the invention.

### DETAILED DESCRIPTION

The present invention is directed to a system and method for facilitating social networking in a physical environment. Reference will now be made in detail to the present exemplary embodiments of the invention, examples of which are illustrated in the accompanying drawings.

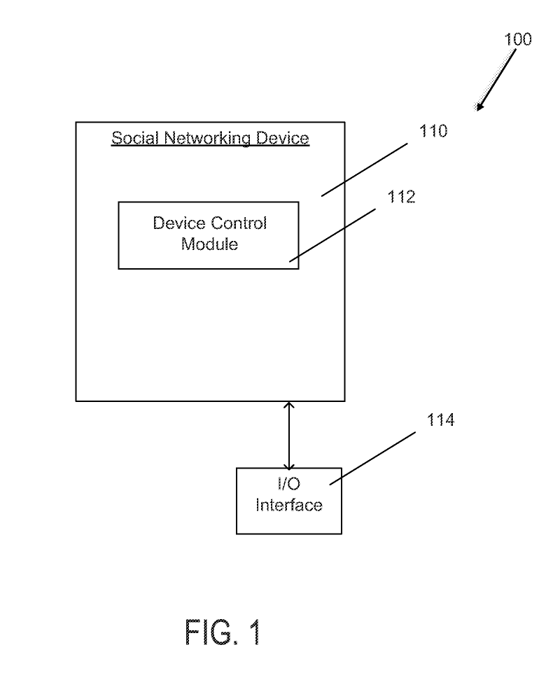

Referring to FIG. 1, a block diagram is shown illustrating a social networking system 100 in accordance with an exemplary embodiment of the invention. The social networking system 100 comprises one or more social networking devices 110 each of which includes a device control module 112, and an Input/Output (I/O) interface 114. The I/O interface 114 may include input mechanisms such as a control panel having control elements such as buttons or switches configured to allow a user or group of users to select social networking participation settings. The input mechanisms may also include communication components for supporting wired (e.g. by way of a serial or Ethernet port) or wireless (e.g. by way of a Bluetooth, IR or 802.11 wireless transceiver) communication with an external device. By way of example, the I/O interface 114 may thus support receipt of information such as configuration settings from an external configuration device or online social networking system. The I/O interface 114 may also include additional output mechanisms or communication components such as one or more colored LED lights for conveying the selected preferences to other individuals in a non-verbal manner.

The social networking device 110 may be an electronic device and the device control module may be an electronic control module (e.g. an ASIC, FPGA, microcontroller or DSP) programmed to handle control information received from and sent to the I/O interface 114. The social networking device 110 may also be an electronic device having a processor and memory such as personal computer, a kiosk, a phone, a mobile phone, or a personal digital assistant. The device 110 may also include a battery for providing power to the control module 112 and I/O interface 114. The I/O interface 114 may also include a keyboard, mouse, monitor, touch screen or similar interface components for allowing a user to interact with the social networking device 110.

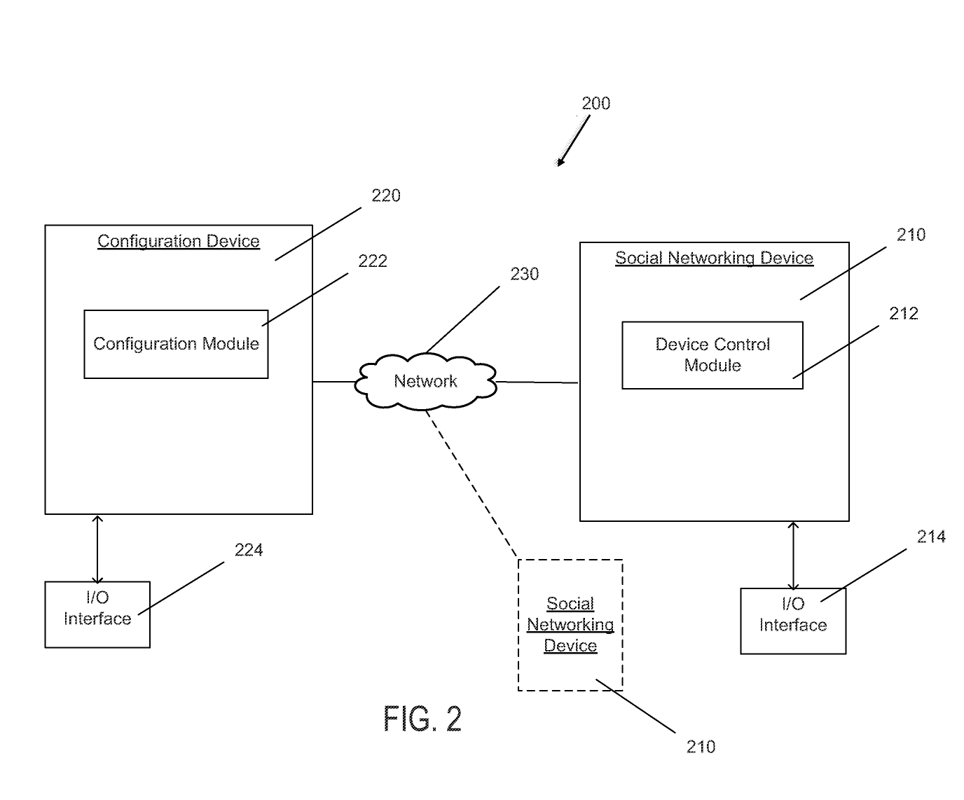

Referring to FIG. 2, a block diagram is shown illustrating a social networking system 200 in accordance with another exemplary embodiment of the invention. The social networking system 200 includes one or more social networking devices 210 configured in a manner similar to the social networking device 110 of FIG. 1. The system 200 also comprises a configuration device 220 communicatively coupled to each of the social networking devices 210 by way of a network 230. The network 230 may be a wired network, a wireless local area network or a wide area network such as the Internet. The configuration device 220 includes a configuration module 222 and an Input/Output (I/O) interface 224.

The I/O interface 224 may include control elements (e.g. a control panel and an LED display) for allowing an administrator of the system (e.g. a manager of a venue) to configure each of the social networking devices 210 in the system 200. The I/O interface may also include communication components for supporting wired (e.g. by way of a serial or Ethernet port) or wireless (e.g. by way of a Bluetooth, IR or 802.11 wireless transceiver) communication with the social networking devices 210. The I/O interface 224 may also include a keyboard, mouse, monitor, touch screen or similar interface device suitable for allowing the administrator to interact with the configuration device 220.

The configuration device 220 may be an electronic device and the configuration module 222 may be an electronic control module (e.g. an ASIC, FPGA, microcontroller or DSP) programmed to handle control information received from and sent to the I/O interface 224 and to each of the social networking devices 210. The configuration device 220 may also be an electronic device having a processor and memory such as personal computer, a kiosk, a phone, a mobile phone, or a personal digital assistant.

The configuration device 220 and social networking devices 210 may be WiFi or Bluetooth-enabled devices capable of supporting wireless communication between one another. The devices may also support wired communication (e.g. Ethernet or serial connections). In such an embodiment the social networking devices 210 may be connected to the configuration device 220 during an initial configuration or reconfiguration of the social networking devices 210. The configuration or reconfiguration step may involve transmitting configuration settings from the configuration device 220 by the configuration module 222 to each of the social networking devices 210. The configuration settings may indicate which preferences (e.g. different levels of participation) are to be associated with which non-verbal indicators (e.g. colored LED lights) on the I/O interface 214. The configuration settings may also indicate which non-verbal indicators are supported during a planned social networking event. The configuration settings may be entered at the I/O interface 224 by an administrator of the system 200 or selected from one of a set of one or more predetermined configurations. Upon completion of the configuration or reconfiguration of the social networking devices 210 the social networking devices 210 may then be disconnected from the configuration device 220 and operate autonomously during the planned social networking event. The social networking devices 210 may optionally remain in communication with the configuration device 220 to allow the administrator of the system to remotely monitor a current state of each device 210. The configuration device 220 may optionally have a data repository for storing predetermined device configurations or statistics collected while monitoring a particular event. The configuration device 220 may access the data repository in response to a request from an administrator or in response to a change in state received from one of the social networking devices.

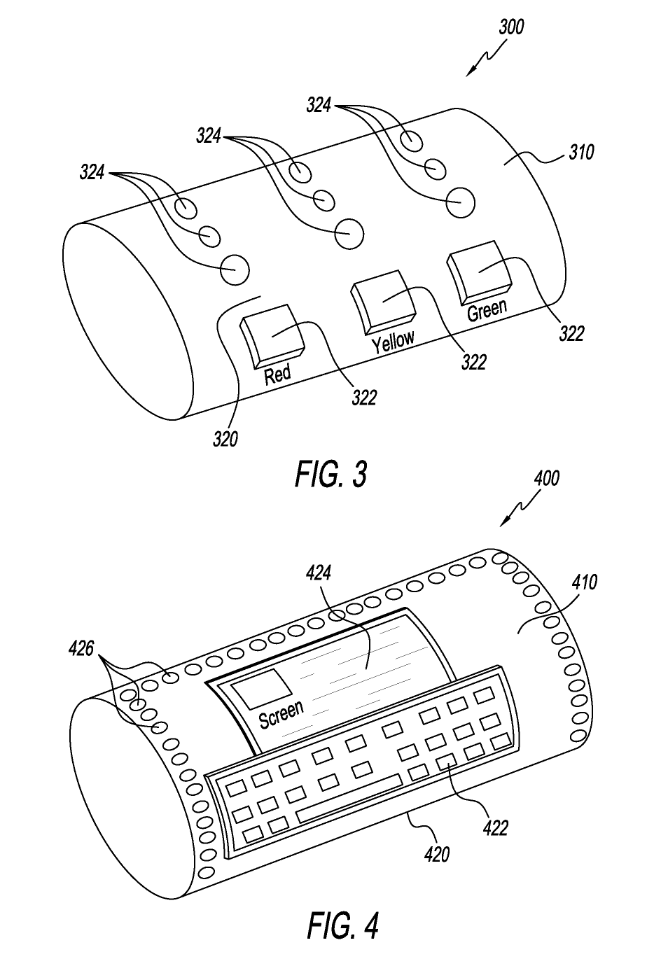

Referring now to FIG. 3 a perspective view of an exemplary social networking device 300 is shown. As shown, the social networking device 300 may be an arm band 310 having a control module (not shown) and an I/O interface 320 attached thereto. The I/O interface 320 includes interface elements such as buttons 322 for providing input to the social networking device 300 and lights 324 for broadcasting participation preferences in a non-verbal manner. Each button 322 may be configured to control one set of lights 324. By way of example the lights 324 may be colored LED lights, each set of lights being capable of displaying at least one color. By way of example, each set of lights may be capable of emitting one or more of the following colors, a blinking mode, or placed in an “OFF” or “NON-PARTICIPATING” state: Green (indicates that the participant is participating in the social networking event); Yellow (indicates that the participant is possibly interested in participating in the social networking event); and Red (indicates that the participant is participating in social networking but not at the present moment—e.g. taking a break). The lights being in the “OFF” state indicates that the participant is not participating in social networking. The blinking or flashing mode can be used to further promote social activity or function. The device 300 may also include a battery (not shown) for supplying power to the control module and I/O interface 320. The arm band 310 may be comprised of a lightweight flexible material such as cloth and include a first end that may be removably coupled (e.g. by buttons, snaps or a hood-and-loop fastener) to a second end for allowing the user to secure the arm band 310 to their body.

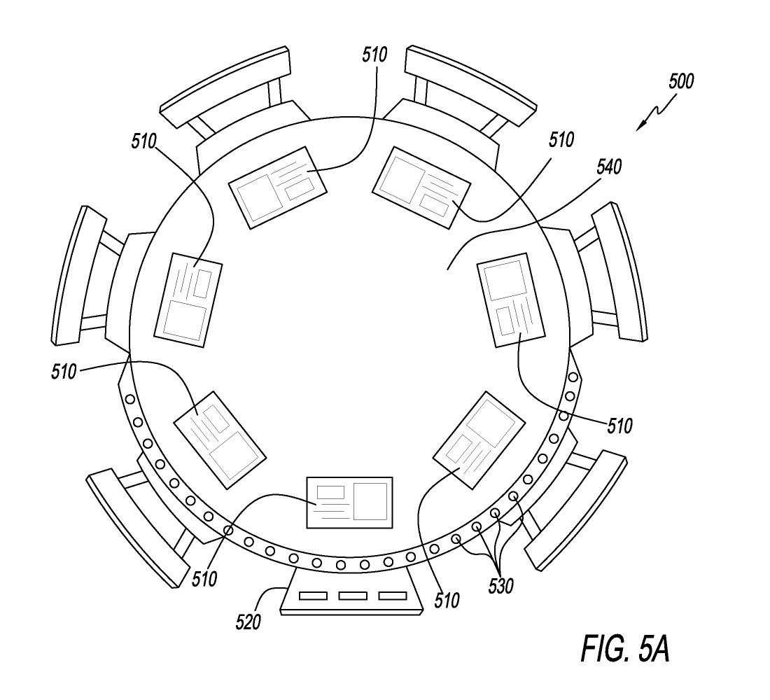

Referring now to FIG. 4 a perspective view of another exemplary social networking device 400 is shown. As shown, the social networking device 400 may be an arm band 410 having a control module (not shown) and an I/O interface 420 attached thereto. The I/O interface 420 includes interface elements such as a keyboard 422 and a display 424. By way of example the display 424 may be an LCD display suitable for allowing a user to view device configuration settings. The keyboard 422 and display 424 may support communication with an online social networking system, game play, real time feedback or the like. The device 400 also includes a plurality of lights 426 for broadcasting participation preferences in a non-verbal manner. The lights 426 may be controlled remotely or via an onboard control module. By way of example, the lights 426 may be colored LED lights, each light being capable of displaying at least one color. Each light may be capable of emitting one or more of the following colors or placed in an “OFF” or “NON-PARTICIPATING” state: Green (indicates that the participant is participating in the social networking event); Yellow (indicates that the participant is possibly interested in participating in the social networking event); and Red (indicates that the participant is participating in social networking but not at the present moment—e.g. taking a break). The lights being in the “OFF” state indicates that the participant is not participating in social networking. The blinking or flashing mode can be used to further promote social activity or function. The device 400 may also include a battery (not shown) for supplying power to the control module and I/O interface 420. The arm band 410 may be comprised of a lightweight flexible material such as cloth and include a first end that may be removably coupled (e.g. by buttons, snaps or a hood-and-loop fastener) to a second end for allowing the user to secure the arm band 410 to their body.

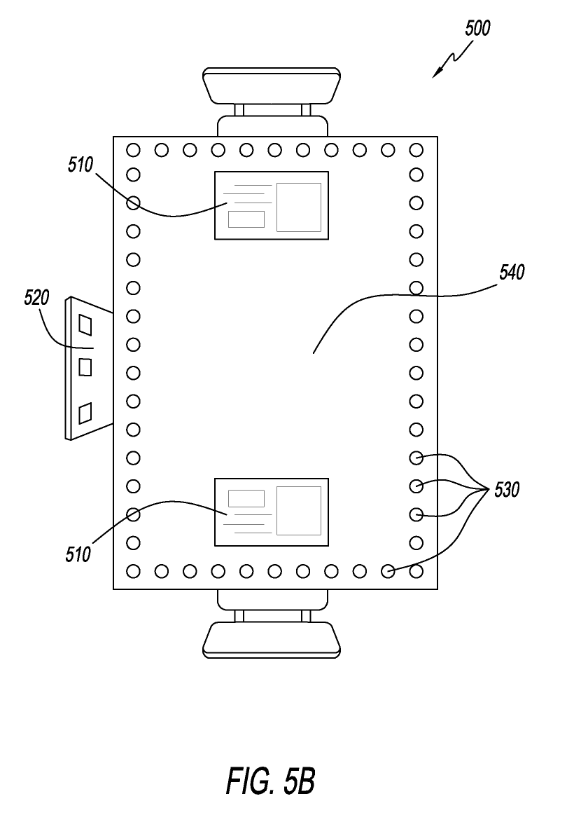

Referring now to FIG. 5A and FIG. 5B, perspective views of a social networking system 500 is shown. As shown, the social networking system 500 includes a plurality of social networking devices 510, a configuration device 520, a plurality of non-verbal indicators 530 such as lights and a table 540. By way of example the lights 530 may be disposed around the periphery of the table 540. The lights 530 may be colored LED lights, each light being capable of displaying at least one color. Each light may be capable of emitting one or more of the following colors or placed in an “OFF” or “NON-PARTICIPATING” state: Green (indicates that the table is participating in social networking and that seating is available); Yellow (indicates that the table is participating in social networking and seating may be available); and Red (indicates that the table is participating in social networking but the number of social networking participants is complete). The lights being in the “OFF” state indicates that the table is not participating in social networking. The social networking system 500 may supports numerous users as shown in FIG. 5A or may support a smaller group of users as shown in FIG. 5B.

As discussed, embodiments of the contemplated social networking devices may be configured as arm bands or tables. However, the social networking devices may also be configured with other types of furniture or apparel such as a clip-on strip, belt, badge, waist band, headband or lightweight vest. The social networking devices may also be floor or wall-mounted or may be provided as stand-alone kiosks. The social networking devices and system may be provided in a venue such but not limited to: a restaurant, corporate cafeteria, nightclub, convention, conference, camp, concert, religious service, college orientation function, classroom or a home party. When the system or devices are provided in an organized setting, signs (posted or electronic) may be placed on the participating tables or in a designated area with additional information (e.g. explaining availability and settings) describing use of the social networking system or devices in the venue. The social networking devices may act as sectional boundaries for the venue, informing by non-verbal means (e.g. colored indicator lights) attributes associated with each section. By way of example, the indicator lights in one section of a venue may emit a particular color for indicating that the section is affiliated with new members of an organization whereas the indicator lights in another section of the venue may emit a different color indicating that the section is affiliated with existing members of an organization.

The contemplated social networking system or devices may also be linked to one or more online social networking systems (e.g. LinkedIn, Facebook, MySpace or Twitter). By way of example the social networking devices may link directly to one of the online social networking systems by way of the Internet. The social networking devices may alternately be linked to an online social networking system by way of a configuration device such as that described with reference to FIG. 2. In such an embodiment the configuration device may be communicatively coupled to one of the online social networking systems by way of the Internet. In this manner, the social networking system provides a mechanism for allowing users participating in an online discussion forum to continue the discussion in a face-to-face setting. Discussion topics may be originated by the online social networking system, an establishment or an individual user. By way of example, discussions that begin in the online forum may then be displayed on table or wall-mounted embodiments of the social networking device to facilitate continuation of the discussion topic in a live setting. The discussion topics may also be listed under categories such as International, National, Regional (metropolitan) and Local. The social networking system and/or devices may also receive configuration settings by way of one of the online social network systems. In such an embodiment, the administrator of the system may be an organizer of a social networking event (e.g. a manager of a musical band or a social event coordinator) not directly affiliated with the venue where the social networking event takes place. This allows the system and/or devices to be decoupled from the venue and to be configured remotely from the venue. In this manner, the contemplated social networking system may thus complement such popular online social networking systems.

In an alternate embodiment, the indicator lights of the contemplated embodiments may be configured to display a variety of colors and patterns (e.g. the lights may blink or strobe at different rates) and with different intensity or brightness. The controller module and I/O interfaces may also be configured to handle additional configuration information. By way of example, the additional configuration information may indicate preferences such as but not limited to: team/club affiliation, alternative styles/interest, or functional representation.

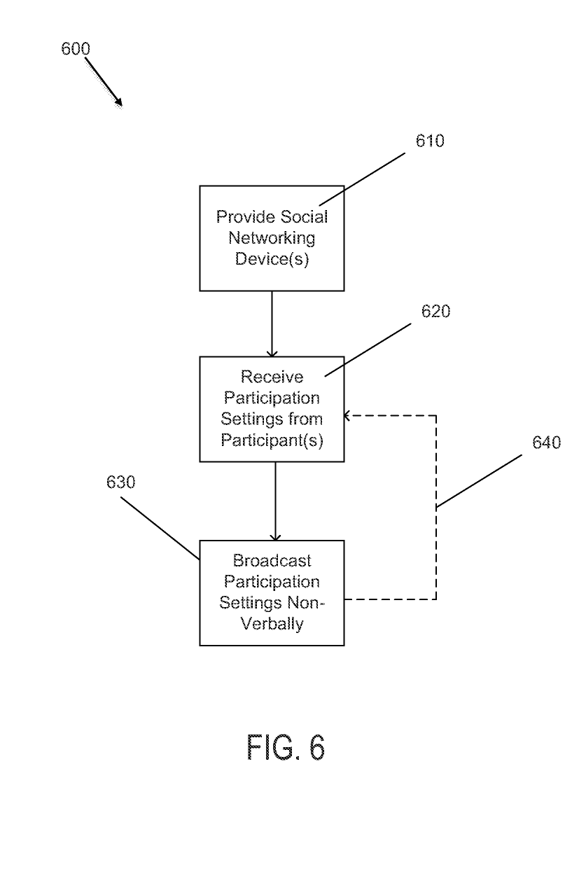

Referring now to FIG. 6 an exemplary process 600 is shown that may be carried out in accordance with the contemplated social networking systems. At a first step 610, one or more social networking devices such as the social networking device 110 of FIG. 1 or the social networking device 210 of FIG. 2 is provided. The social networking devices may be provided by a potential participant or by an administrator of the social networking system. By way of example, the administrator may be a manager of a venue or an organizer of an event occurring at a venue. It is noted that the administrator may also be a user of one of the social networking devices and accordingly a participant in the social networking system. At a next step 620, the one or more social networking devices receive participation parameters from the I/O interface operated by potential participants. The participation parameters include instructions suitable for indicating whether the potential participants elect to participate (i.e. a “PARTICIPATING” state) or not to participate (i.e. a “NOT PARTICIPATING” state) in the social network. The participation parameters may also include instructions indicating different levels of participation. When the social networking device is one that is used by multiple people, the users may select one of several levels of participation including: an indication that the potential participants are currently participating in social networking and that space is available for additional people to participate; an indication that the potential participants are currently participating in social networking and space may be available; and an indication that the potential participants are currently participating in social networking but that no additional space is currently unavailable. The social networking devices may initially be configured in the “NOT PARTICIPATING” state. Alternatively, the devices may initially be configured to be in one of the “PARTICIPATING” states to indicate that the location on which they are placed (e.g. a table) is open to social networking. People interested in participating in such a system may elect to participate by moving into proximity of the social networking device. When initially configured in the “NOT PARCTIPATING” state the first participant may use the I/O interface of the social networking device to switch the device to one of the “PARCTIPATING” states. As additional participants join, the users of a particular social networking device may change the configuration of the device (as indicated by the arrow labeled 640) to one of the other “PARTICIPATING” states, to indicate that the device is no longer accepting new participants or that space is limited. Users and groups may also use the I/O interface of the social networking device to associate the social networking device with different attributes (e.g. political affiliation, team affiliation, marital status, personality). In an individual user embodiment, users may each have their own social networking device that may, as previously discussed, be a similar standalone device or integrated into a form of apparel (e.g. a wristband, headband, badge, arm band, vest, belt).

At a next step 630, the social networking device broadcasts the social networking participation preferences including any user/group attributes by non-verbal means. The non-verbal means may include indicator lights capable of emitting one more colors, each color being associated with one of the participation preferences. By way of example, the social networking device may have multiple lights capable of emitting one or more of the following colors when in the “PARTICIPATING” state: Green (indicates that the user or group is participating in social networking and that space is available for additional participants); Yellow (indicates that the potential participants are participating in social networking and space may be available); and Red (indicates that the user or group is participating in social networking but the number of social networking participants is complete). Potential participants may decide to interact with one another based on the non-verbal messages communicated from the social networking device being operated by other participants or groups of participants. The steps of receiving preferences/attributes and broadcasting such preferences/attributes may be repeated during the course of a social networking event, as indicated by line 640, as users or groups of users update their participation preferences.

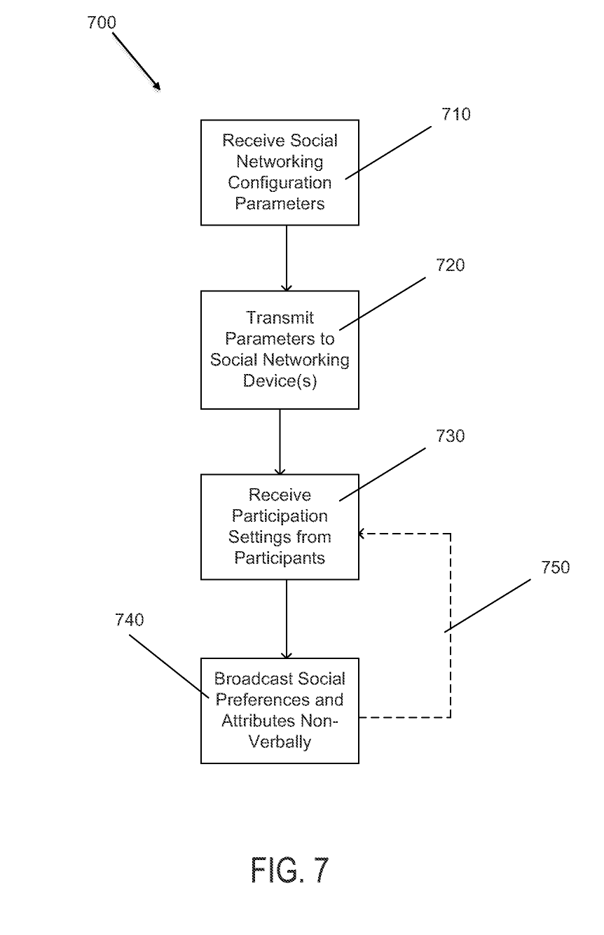

Referring now to FIG. 7 another exemplary process 700 is shown that may be carried out in accordance with the contemplated social networking systems. At a first step 710, social networking configuration parameters are received by a social networking configuration device such as the configuration device 220 of FIG. 2 which as discussed may be local or remotely located from a venue where the social networking devices may be employed. The social networking configuration parameters may include one or more pairings of attributes (e.g. social networking participation preference options) with non-verbal indicators (e.g. color, light pattern, or light intensity). The configuration device may receive these parameters from an administrator by way of the configuration device I/O interface. By way of example, the administrator may be a manager of a venue or an organizer of an event occurring at a venue. It is noted that the administrator may also be a user of one of the social networking devices and accordingly a participant in the social networking system. The administrator may optionally use an online social networking system to configure the social networking devices for a social networking event. In certain embodiments the social networking system may be decoupled from a particular venue (i.e. the configuration device is either remotely located from the venue or the administrator configures the event by way of a social networking web site). In such embodiments the administrator may also provide venue information (e.g. venue name, venue street address, venue GPS coordinates) when configuring a social networking event.

The process proceeds at a next step 720, where the configuration device transmits configuration parameters to each of one or more social networking devices (e.g. the devices 210 of FIG. 2) that are located at an associated venue. The social networking devices may be provided by a potential participant or by an administrator of the social networking system. The social networking devices use the received parameters to determine what attributes are associated with each possible non-verbal indicator (e.g. each colored indicator light). At a next step 730, each of the one or more social networking devices receives participation parameters from the I/O interface operated by potential participants. The participation parameters may include instructions suitable for indicating whether the potential participants elect to participate (i.e. a “PARTICIPATING” state) or not to participate (i.e. a “NOT PARTICIPATING” state) in the social networking event. The participation parameters may also include instructions indicating different levels of participation. When the social networking device is one that is used by multiple people, the users may also select one of several levels of participation including: an indication that the potential participants are currently participating in social networking and that space is available; an indication that the potential participants are currently participating in social networking and space may be available; and an indication that the potential participants are currently participating in social networking but that no additional space is currently unavailable. The social networking devices may initially be configured in the “NOT PARTICIPATING” state. Alternatively, the devices may initially be configured to be in one of the “PARTICIPATING” states to indicate that the location on which they are placed (e.g. a table) is open to social networking. People interested in participating in such a system may elect to participate by moving into proximity of the social networking device. When initially configured in the “NOT PARCTIPATING” state the first participant may use the I/O interface of the social networking device to switch the device to one of the “PARCTICPATING” states. As additional participants join, the users of a particular social networking device may change the configuration of the device (as indicated by the arrow labeled 750) to one of the other “PARTICIPATING” states, to indicate that the device is no longer accepting new participants or that space is limited. Users and groups may also use the I/O interface of the social networking device to associate the social networking device with different attributes (e.g. political affiliation, team affiliation, marital status). In an individual user embodiment, users may each have their own social networking device that may, as previously discussed, be a similar standalone device or integrated into a form of apparel (e.g. a wristband, headband, arm band, belt).

At a next step 740, each social networking device broadcasts the social networking participation preferences and any users/group attributes by non-verbal means. The non-verbal means may include indicator lights capable of emitting one or more colors, each color being associated with one of the participation preferences or attributes. By way of example, the social networking device may have multiple lights capable of emitting one or more of the following colors when in the “PARTICIPATING” state: Green (indicates that the user or group is participating in social networking and that space is available for additional participants); Yellow (indicates that the potential participants are participating in social networking and seating may be available); and Red (indicates that the table is participating in social networking but the number of social networking participants is complete). Potential participants may decide to interact with one another based on the non-verbal messages communicated from the social networking device being operated by other participants or groups of participants. The steps of receiving preferences/attributes and broadcasting such preferences/attributes may be repeated during the course of a social networking event, as indicated by line 750, as users or groups of users update their participation preferences or attributes.

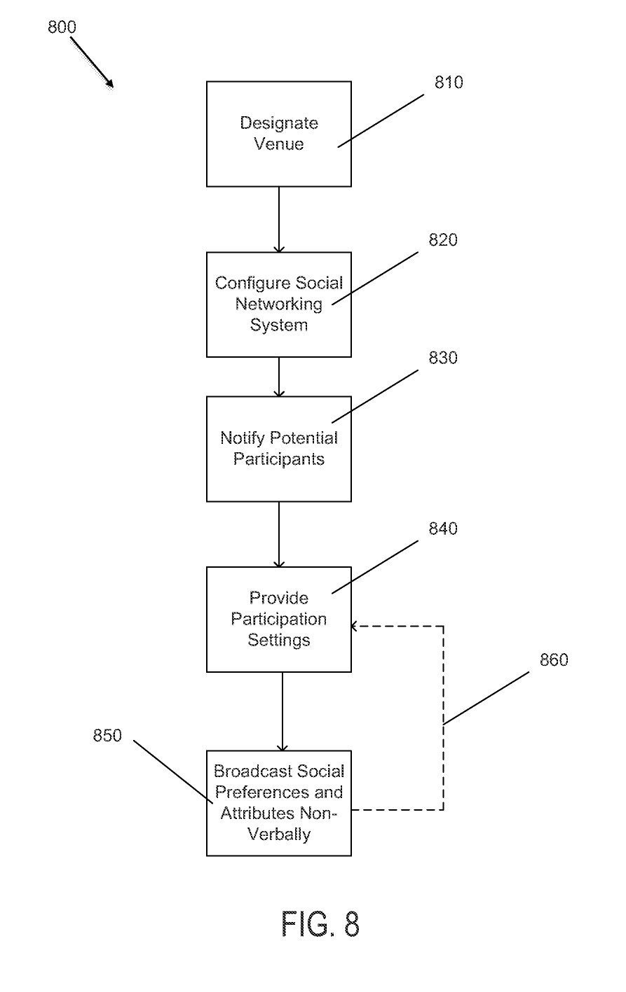

Referring now to FIG. 8, another exemplary process 800 is shown that may be carried out in accordance with the contemplated social networking systems. At a first step 810, an administrator designates a venue or an area within a venue where a social networking event will take place. By way of example, the administrator may be a manager of a venue or an organizer of an event occurring at a venue. It is noted that the administrator may also be a user of one of the social networking devices and accordingly a participant in the social networking system.

At a next step 820, the administrator configures the social networking system by way of a local or remotely located configuration device such as the configuration device 220 shown in FIG. 2. The administrator may optionally use one of the online social networking systems to configure the social networking devices for the social networking event. Configuring the social networking devices may include entering one or more pairings of attributes (e.g. social networking preferences) with non-verbal indicators (e.g. colors). In certain embodiments the system may be decoupled from the venue (i.e. the configuration device is either remotely located from the venue or the administrator configures the event by way of a social networking web site). In such embodiments the administrator may also provide venue information (e.g. venue name, venue street address, venue GPS coordinates) when configuring a social networking event.

The process proceeds at a next step 830, when customers or potential participants are made aware of the social networking event upon arriving at the venue and are subsequently invited to participate. This notification step may be carried out by placement of electronic or posted signage (e.g. by the administrator) at the venue. In an alternate embodiment users may be notified of the social networking event in advance (e.g. by e-mail, or via an online social networking site). In another embodiment, users may be notified in real-time by way of a visual notification received on a personal computing device such as a mobile phone from the configuration device.

At a next step 840, the potential participants provide participation parameters to the one or more social networking devices by way of the I/O interface. The configuration parameters include instructions suitable for indicating whether the potential participants elect to participate (i.e. a “PARTICIPATING” state) or not to participate (i.e. a “NOT PARTICIPATING” state) in the social network. The configuration parameters may also include instructions indicating different levels of participation. When the social networking device is one that is used by multiple people, the users may also select one of several levels of participation including: an indication that the potential participants are currently participating in social networking and that space is available; an indication that the potential participants are currently participating in social networking and space may be available; and an indication that the potential participants are currently participating in social networking but that no additional space is currently unavailable. The social networking devices may initially be configured in the “NOT PARTICIPATING” state. Alternatively, the devices may initially be configured to be in one of the “PARTICIPATING” states to indicate that the location on which they are placed (e.g. a table) is open to social networking. People interested in participating in such a system may elect to participate by moving into proximity of the social networking device. When initially configured in the “NOT PARCTIPATING” state the first participant may use the I/O interface of the social networking device to switch the device to one of the “PARCTICPATING” states. As additional participants join, the users of a particular social networking device may change the configuration of the device (as indicated by the arrow labeled 860) to one of the other “PARTICIPATING” states, to indicate that the device is no longer accepting new participants or that space is limited. Users and groups may also use the I/O interface of the social networking device to associate the social networking device with different attributes (e.g. political affiliation, team affiliation, marital status). In an individual user embodiment, users may each have their own social networking device that may, as previously discussed, be a similar standalone device or integrated into a form of apparel (e.g. a wristband, headband, arm band, belt).

At a next step 850, the social networking device broadcasts the social networking participation preferences and any users/group attributes by non-verbal means. The non-verbal means may include indicator lights capable of emitting one more colors or light patterns (e.g. blinking or flashing), each color or pattern being associated with one of the participation preferences or attributes. By way of example, the social networking device may have multiple lights capable of emitting one or more of the following colors when in the “PARTICIPATING” state: Green (indicates that the user or group is participating in social networking and that space is available for additional participants); Yellow (indicates that the potential participants are participating in social networking and seating may be available); and Red (indicates that the table is participating in social networking but the number of social networking participants is complete). Potential participants may decide to interact with one another based on the non-verbal messages communicated from the social networking device being operated by other participants or groups of participants. The steps of receiving preferences/attributes and broadcasting such preferences/attributes may be repeated during the course of a social networking event, as indicated by line 860, as users or groups of users update their participation preferences or attributes.

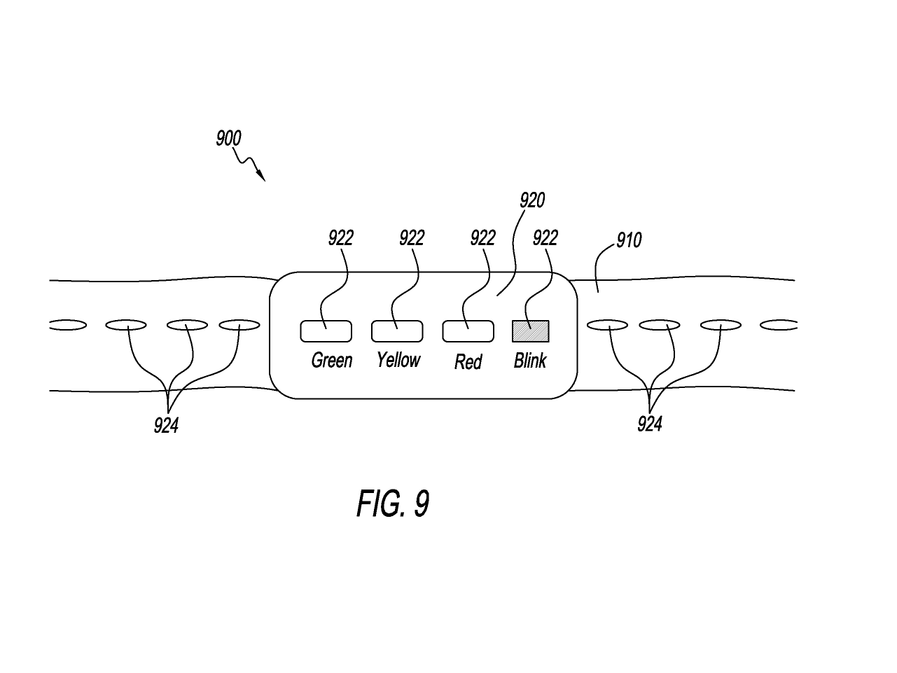

Referring now to FIG. 9, a perspective view of another exemplary social networking device 900 is shown. As shown, the social networking device 900 may be a belt 910 having a control module (not shown) and an I/O interface 920 attached thereto. The I/O interface 920 includes interface elements such as buttons 922 for controlling characteristics (e.g. color or light patterns) of a plurality of lights 926 disposed on the surface of the belt 910. The lights 924 are configured to broadcast participation preferences in a non-verbal manner and may be controlled via an onboard control module. By way of example, the lights 924 may be colored LED lights, each light being capable of displaying at least one color. Each light may be capable of emitting one or more of the following colors or placed in an “OFF” or “NON-PARTICIPATING” state: Green (indicates that the participant is participating in the social networking event); Yellow (indicates that the participant is possibly interested in participating in the social networking event); and Red (indicates that the participant is participating in social networking but not at the present moment—e.g. taking a break). The lights being in the “OFF” state indicates that the participant is not participating in social networking. The blinking or flashing mode can be used to further promote social activity or function. The device 900 may also include a battery (not shown) for supplying power to the control module and I/O interface 920. The belt 910 may be comprised of a lightweight flexible material such as leather and include a first end that may be removably coupled (e.g. by buttons, snaps or a hood-and-loop fastener) to a second end for allowing the user to secure the belt 910 to their body.

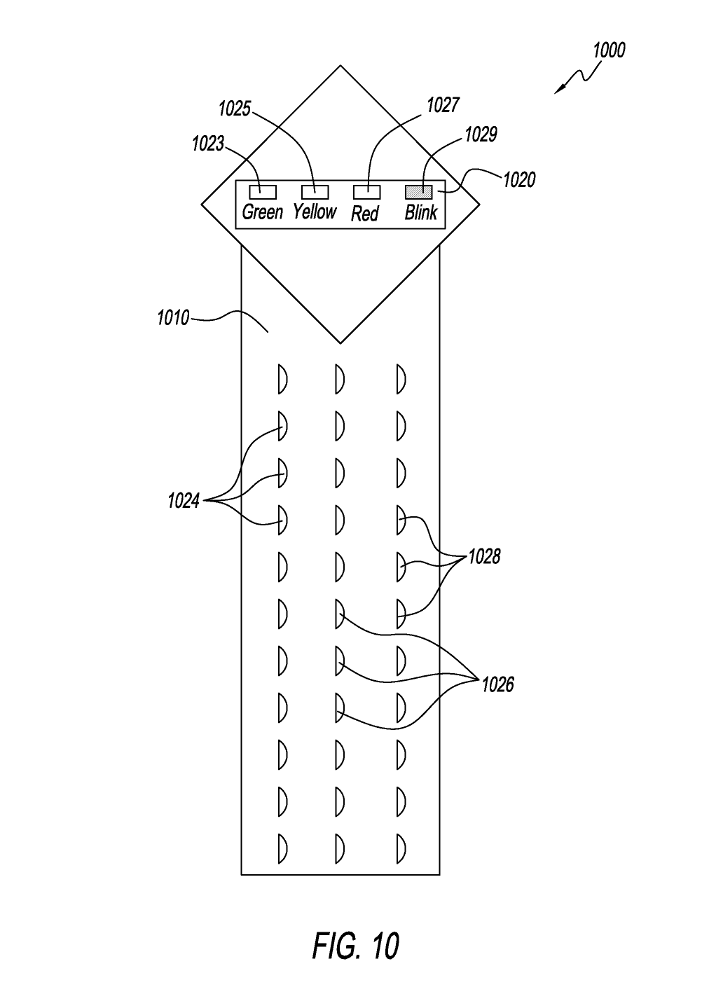

Referring now to FIG. 10, a perspective view of another exemplary social networking device 1000 is shown. As shown, the social networking device 1000 may be a badge 1010 having a control module (not shown) and an I/O interface 1020 attached thereto. The badge 1010 may be removably attachable to a human or article of clothing by way of a clip, lanyard or similar attachment mechanism. The I/O interface 1020 includes interface elements such as buttons 1023, 1025, 1027 and 1029 for controlling characteristics (e.g. color, intensity or strobing patterns) of a plurality of lights 1024, 1026 and 1028 arranged in columns on the surface of the badge 1010. The lights are configured to broadcast participation parameters in a non-verbal manner and may be controlled via an onboard control module. By way of example, the lights 1024, 1026 and 1028 may be colored LED lights, each light being capable of displaying at least one color. Each light may be capable of emitting one or more of the following colors or placed in an “OFF” or “NON-PARTICIPATING” state: Green (indicates that the participant is participating in the social networking event); Yellow (indicates that the participant is possibly interested in participating in the social networking event); and Red (indicates that the participant is participating in social networking but not at the present moment—e.g. taking a break). The lights being in the “OFF” state indicates that the participant is not participating in social networking. The blinking or flashing mode can be used to further promote social activity or function. It is noted that various strobing patterns or levels of intensity may be employed to convey different participation preferences. Each of the buttons 1023, 1025, and 1027 may control the characteristics (e.g. color intensity or strobing pattern) of the lights 1024, 1026 and 1028 or may control a subset (e.g. one column) of lights. By way of example, when a user selects the button 1023 labeled “Green” all of the lights 1024, 1026 and 1028 may display the color green to indicate that the user is participating in social networking. Selecting the button 1025 labeled “Yellow” may then cause all of the lights 1024, 1026 and 1028 to display the color yellow to indicate that the user is possibly interested in participating in social networking. Selecting the button 1027 labeled “Red” may then cause all of the lights 1024, 1026 and 1028 to display the color red to indicate that the user is participating in social networking but not at the present moment. The buttons 1023, 1025 and 1027 may thus control all of the lights 1024, 1026 and 1028 in a mutually exclusive manner. In an alternate embodiment however each of the buttons 1023, 1025 and 1027 may independently control a subset of the lights. By way of example, the button 1023 may control the lights 1024 in a first column. The button labeled 1025 may control the lights 1026 in a second column. The button labeled 1027 may control the lights 1028 in a third column. Each of the sets of lights 1024, 1026 and 1028 may be capable of emitting a different color. By allowing the user to control each set of lights independently, the device 1000 can be used to simultaneously convey multiple non-verbal messages. The device 1000 may also include a battery (not shown) for supplying power to the control module and I/O interface 1020. The badge 1010 may be comprised of a lightweight material such as leather or cloth and include a first end that may be removably coupled (e.g. by a hook, button, snap or a hood-and-loop fastener) to a lanyard, or other form of apparel for allowing the user to secure the badge 1010 to their body.

As previously discussed three colors such as green, yellow and red may be used for conveying various levels of desired participation in a social networking event. However, it is noted that this is for illustrative purposes only. Fewer colors and lights as well as additional colors and lights may be employed without departing from the sprit or scope of the invention. The colors emitted from each of the lights may also be used to convey different non-verbal messages, useful for example in a night-club or meet-and-greet setting. By way of example, four colors may be employed where a first color may be used to convey that the user falls into a first age range (e.g. under 30), a second color may convey a second age range (e.g. under 40), a third color may convey a first relationship status (e.g. single and never married) and a fourth color may convey a second relationship status (e.g. single and divorced). Alternatively, the arrangement of the lights on the device may be used to convey a particular type of non-verbal message. By way of example, the lights may be arranged in columns, wherein each column is associated with a particular type or category of message. The lights of each column may also be capable of emitting multiple colors, each color conveying more detail with regard to the message being conveyed by the column. By way of example, the lights of a first column may be used to display a message related to the user's age and each color may correspond to particular age ranges (e.g. under 30, 31-40, 41-50, 51+). The lights of a second column may relate to marital status and each color may correspond to a particular marital status (e.g. single, married, divorced, and widowed). The lights of a third column may relate to the user's relationship interests and each color may correspond to a particular type of relationship (e.g. casual dating, love). The light of a fourth column may relate to the user's education and each color may correspond to a particular education level (e.g. high school, bachelor's degree, master's degree, PhD or professional). The same colors may be displayed in multiple columns, thus the location of the lights (e.g. within a particular column), in addition to the color being emitted has significance when conveying the non-verbal message.

In another embodiment, each color displayed by the lights may be associated with a personality type (e.g. one of the Myer's-Briggs personality types). Each user may possess varying levels of each personality type which may be conveyed by displaying greater or fewer number of lights that emit the associated color or by displaying each color with a different level of intensity or brightness. In such an embodiment a first color may correspond to Extroversion vs. Introversion with more lights or greater intensity being associated with greater extroversion and fewer light or less intensity being associated with greater introversion. A second color may correspond to Sensing vs. Intuition with more lights or greater intensity being associated with greater sensing and fewer lights or less intensity being associated with greater intuition. A third color may correspond to Thinking vs. Feeling with more lights or greater intensity being associated with greater thinking and fewer light or less intensity being associated with greater feeling. A fourth color may correspond to Judging vs. Perceiving with more lights or greater intensity being associated with greater judging and fewer light or less intensity being associated with greater perceiving.

In a further embodiment, the device may be used at a political convention. In such an embodiment a first column or group of lights may correspond to political affiliation with a first color corresponding to a first political party (e.g. Democrat), a second color corresponding to a second political party (e.g. Republican) and a third color corresponding to a third political party (e.g. Independent). A second column or group of lights may correspond to political ideology with a first color corresponding to a first political ideology (e.g. Conservative) and a second color corresponding to a second political ideology (e.g. Liberal). A third column or group of lights may correspond to the user's geographic residence with a first color corresponding to a first region (e.g. Northeast), a second color corresponding to a second region (e.g. Southeast), a third color corresponding to a third region (e.g. West) and a fourth color corresponding to a fourth region (e.g. Mid-west). A fourth column or group of lights may correspond to the user's military service with a first color corresponding to a first branch of the military (e.g. Army), a second color corresponding to a second branch of the military (e.g. Navy), a third color corresponding to a third branch of the military (e.g. Air Force), and a fourth color corresponding to a fourth branch of the military (e.g. Marines).

Thus, an improved social networking system and method is contemplated. The system may be used in a venue such as a restaurant, cafeteria, nightclub, convention or camp. The contemplated system includes one or more social networking devices capable of providing non-verbal messages to other users of the system. The non-verbal messages may be color-coded visual indicators such as lights (e.g. LEDs). By way of example, the color-coded visual indicators may be placed on or around tables and may be configured to indicate a level of participation by an individual or group in the social networking system. The visual indicators may also be integrated into apparel such as a wristband, belt, or arm band and worn by a user that wishes to participate in the social networking system at such a venue that supports the social networking system. The system may also provide simultaneous conveyance of multiple non-verbal indicators. Each non-verbal indicator may correspond to a desired level of participation in a social networking event or an attribute (e.g. a particular political party, a team affiliation, or marital status) associated with the user or group using the device.

The various illustrative program modules and steps described in connection with the embodiments disclosed herein may be implemented as electronic hardware, computer software, or combinations of both. The various illustrative program modules and steps have been described generally in terms of their functionality. Whether the functionality is implemented as hardware or software depends in part upon the hardware constraints imposed on the system. Hardware and software may be interchangeable depending on such constraints. As examples, the various illustrative program modules and steps described in connection with the embodiments disclosed herein may be implemented or performed with an application specific integrated circuit (ASIC), a field programmable gate array (FPGA) or other programmable logic device, discrete gate or transistor logic, discrete hardware components, a conventional programmable software module and a processor, or any combination thereof designed to perform the functions described herein. The processor may be a microprocessor, CPU, controller, microcontroller, programmable logic device, array of logic elements, or state machine. The software module may reside in RAM memory, flash memory, ROM memory, EPROM memory, EEPROM memory, hard disk, a removable disk, a CD, DVD or any other form of storage medium known in the art. An exemplary processor may be coupled to the storage medium so as to read information from, and write information to, the storage medium. In the alternative, the storage medium may be integral to the processor.

In further embodiments, those skilled in the art will appreciate that the foregoing methods can be implemented by the execution of a program embodied on a computer readable medium. The medium may comprise, for example, RAM accessible by, or residing within the device. Whether contained in RAM, a diskette, or other secondary storage media, the program modules may be stored on a variety of machine-readable data storage media, such as a conventional “hard drive”, magnetic tape, electronic read-only memory (e.g., ROM or EEPROM), flash memory, an optical storage device (e.g., CD, DVD, digital optical tape), or other suitable data storage media.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A method of facilitating social networking comprising:
providing one or more social networking devices, each social networking device having:
a control module;
one or more input mechanisms; and
one or more output mechanisms;
receiving by the one or more input mechanisms at least one participation parameter associated with a social networking event, each participation parameter being provided by at least one potential participant;
selecting by the control module at least one non-verbal indicator, each selected non-verbal indicator being associated with one of the at least one received participation parameters, each non-verbal indicator being selected from one or more predetermined non-verbal indicators; and
broadcasting by the one or more output mechanisms each selected non-verbal indicator.

2. The method of claim 1, wherein the one or more output mechanisms comprises one or more indicator lights; and
wherein each non-verbal indicator is a color and the broadcasting further comprises an emission of the color by one or more of the indicator lights.

3. The method of claim 2, wherein the one or more participation parameters are selected from one of: a desired participation level and an attribute associated with the at least one potential participants.

4. The method of claim 3, wherein the one or more attributes associated with the at least one potential participant is selected from one of: a political party, a team affiliation, a marital status, a discussion topic and a personality type.

5. The method of claim 3, wherein the desired participation level is selected from one of: a non-participating state, the non-participating state indicating that the potential participants do not desire to participate in the social networking event; and a participating state, the participating state indicating that the potential participants do desire to participate in the social networking event.

6. The method of claim 5, wherein the participating state is selected from one of: an indication that the potential participants are currently participating in social networking and that space is available for accepting new participants; and, an indication that the potential participants are currently participating in social networking but that no additional space is currently unavailable for accepting new participants.

7. The method of claim 5, wherein the one or more input mechanisms is selected from: one or more buttons, one or more toggles, a keyboard, a touch-screen display, a mouse and display.

8. The method of claim 4, further comprising:
receiving one or more configuration settings, each configuration setting comprising a pairing between one of the at least one participation parameters and one of the at least one non-verbal indicators; and
wherein the step of selecting each of the non-verbal indicators is based on the received configuration settings.

9. The method of claim 8, wherein the one or more configuration settings are received from a configuration device.

10. The method of claim 8, wherein the one or more configuration settings are received from an online social networking system.

11. The method of claim 4, further comprising:
providing a configuration device having a configuration control module, the configuration device being communicatively coupled to the one or more social networking devices;
receiving by the configuration device one or more configuration settings, each configuration setting comprising a pairing between one of the at least one participation parameters and one of the at least one non-verbal indicators; and
transmitting the one or more configuration settings to one or more of the one or more social networking devices.

12. A social networking system comprising:
one or more social networking devices, each social networking device having:
one or more input mechanisms adapted to receive at least one participation parameter associated with a social networking event, each participation parameter being provided by at least one potential participant;
a control module adapted to select at least one non-verbal indicator, each selected non-verbal indicator being associated with one of the at least one received participation parameters, each non-verbal indicator being selected from one or more predetermined non-verbal indicators; and
one or more output mechanisms adapted to broadcast each selected non-verbal indicator.

13. The system of claim 12, wherein the one or more output mechanisms comprises one or more indicator lights; and
wherein the non-verbal indicator is a color and the broadcasting is carried out by emission of the color by one or more of the indicator lights.

14. The system of claim 12, wherein the one or more output mechanisms comprises one or more indicator lights; and
wherein the non-verbal indicator is selected from at least one of: color, brightness and blinking frequency.

15. The system of claim 14, further comprising a plurality of indicator lights arranged in a plurality of groups and wherein each group of indicator lights is independently controlled by one of the one or more input mechanisms.

16. The system of claim 14, wherein at least one of the one or more social networking devices includes a table; and wherein the indicator lights are disposed on the table.

17. The system of claim 14, wherein at least one of the one or more social networking devices further comprises an arm band, the arm band configured to have the one or more indicator lights, the one or more output mechanisms and the controller module each attached thereto.

18. The system of claim 15, further comprising:
a configuration device communicatively coupled to the one or more social networking devices, the configuration device having a configuration control module adapted to:
receive one or more configuration settings, each configuration setting comprising a pairing between one of the at least one participation parameters and one of the at least one non-verbal indicators; and
transmit each of the one or more configuration settings to at least one of the one or more social networking devices.

19. The system of claim 12, wherein at least one of the one or more social networking devices is communicatively coupled to an online social networking system and is adapted to receive one or more configuration settings from the online social networking system, each configuration setting comprising a pairing between one of the at least one participation parameters and one of the at least one non-verbal indicators.

20. A method of facilitating social networking comprising:
providing one or more social networking devices, each social networking device having:
a control module adapted to select at least one non-verbal indicator, each selected non-verbal indicator being associated with one of one or more received participation parameters, each non-verbal indicator being selected from one or more predetermined non-verbal indicators;
one or more input mechanisms adapted to:
receive the one or more participation parameters associated with a social networking event, each participation parameter being provided by at least one potential participant;
receive at least one configuration setting, each configuration setting being provided by an administrator of the system and wherein each configuration setting comprises a pairing between one of the at least one participation parameters and one of the at least one non-verbal indicators; and
one or more output mechanisms adapted to broadcast each selected non-verbal indicator;
providing a configuration device communicatively coupled to the one or more social networking devices, the configuration device having a configuration control module adapted to:
receive the or more configuration settings; and
transmit each of the one or more configuration settings to at least one of the one or more social networking devices;
inputting by the administrator one or more configuration settings to the configuration device; and
initiating by the administrator transmission of the one or more configuration settings to one or more of the one or more social networking devices.
